(19) United States
(12) Patent Application Publication
(10) Pub. No.: US 2010/0165978 A1
(43) Pub. Date: Jul. 1, 2010

(54) METHOD AND APPARATUS FOR PROVIDING AN AUTOMATED SHOPPING SERVICE IN A TELECOMMUNICATION SYSTEM

(76) Inventors: John Mathew, Emerson, NJ (US); Jacob Thomas, JR., New Milford, NJ (US)

Correspondence Address: MOSER IP LAW GROUP / VONAGE, 1030 BROAD STREET, 2ND FLOOR, SHREWSBURY, NJ, 07702, US

(21) Appl. No.: 12/345,209

(22) Filed: Dec. 29, 2008

(51) Int. Cl. H04L 12/66; G10L 15/26; H04W 4/12; G06Q 30/00; G06F 17/30

(52) U.S. Cl. 370/352; 704/235; 455/466; 705/26; 707/E17.018; 707/E17.032

(57) ABSTRACT

Method and apparatus for providing an automated shopping service in a telecommunication system are described. In some examples, a call is received via the telecommunication system initiated by a caller. An electronic prompt is played to the caller. An electronic response is received from the caller in response to the electronic prompt. At least one item requested by the caller is automatically detected in the electronic response. A search is performed of at least one shopping source to obtain information associated with the at least one item. The information is sent to towards the caller.

### BACKGROUND OF THE INVENTION

1. Field of the invention

The present invention relates generally to telecommunication systems and, more particularly, to a method and apparatus for providing an automated shopping service in a telecommunication system.

2. Description of the Related Art

Voice over IP (VoIP) is a recent technological development in the field of telecommunications that is utilized to transmit voice conversations over a data network using the Internet Protocol (IP). Entities (either businesses or individuals) use VoIP by purchasing and installing a minimal amount equipment (a Customer Premise Equipment (CPE) device) to access a VoIP service provider and subscribing to this telecommunication service. After the VoIP service has been subscribed to, and depending on the level of service requested, an entity can make phone calls to other VoIP subscribers or to public switched telephone network (PSTN) customers and access a number of features associated with the VoIP service such as an Instant Messaging Service, an address book feature and the like. VoIP services offer various features, such as call waiting, call forwarding, do not disturb, caller ID, and the like. Tying services and features together adds to the flexibility and pervasiveness of VoIP service in general so that its adoption becomes increasingly widespread. Heretofore, there has been no advancement in exploiting the benefits of VoIP networks in providing an automated shopping service.

Therefore, there is a need in the art for providing an automated shopping service using an IP-based telecommunications system, such as VoIP.

### SUMMARY OF THE INVENTION

Embodiments of the invention relate to a method, apparatus, and computer readable medium providing an automated shopping service in a telecommunication system. In some embodiments, a call is received via the telecommunication system initiated by a caller. An electronic prompt is played to the caller. An electronic response is received from the caller in response to the electronic prompt. At least one item requested by the caller is automatically detected in the electronic response. A search is performed of at least one shopping source to obtain information associated with the at least one item. The information is sent to towards the caller.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram depicting an exemplary embodiment of a communication system in accordance with one or more aspects of the invention;

FIG. 2 is a flow diagram depicting an exemplary embodiment of a method of providing an automated shopping service using a telecommunications system in accordance with one or more aspects of the invention;

FIG. 3 is a flow diagram depicting an exemplary embodiment of a method for automatically detecting items requested by the caller within an electronic response in accordance with one or more aspects of the invention; and

FIG. 4 is a block diagram depicting an exemplary embodiment of a shopping service server in accordance with one or more aspects of the invention.

### DETAILED DESCRIPTION

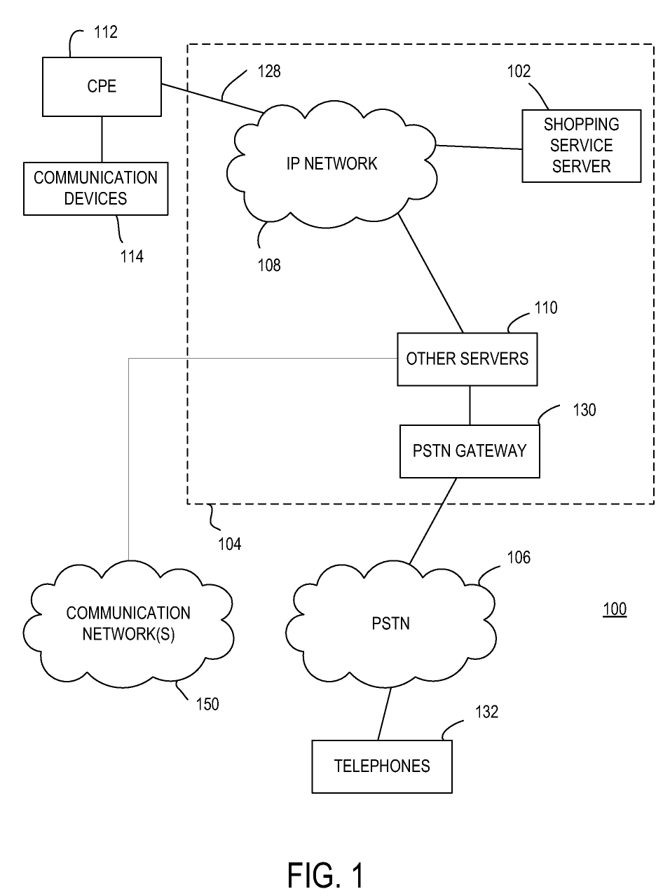

FIG. 1 is a block diagram depicting an exemplary embodiment of a communication system 100 in accordance with one or more aspects of the invention. The communication system 100 includes a voice-over-internet-protocol (VOIP) network 104 (generally referred to as a telecommunication system) and a public switched telephone network (PSTN) 106. The VOIP network 104 includes a shopping service server 102 and a plurality of other servers 110 coupled to an internet protocol (IP) network 108. The servers 110 may include various well known servers configured to facilitate VOIP services, such as provisioning servers, proxy servers, media relay servers, and the like. The shopping service server 102 is configured to provide a shopping service to subscribers of a VOIP service which uses the VOIP network 104, as described below. The servers 102 and 110 may be implemented using a plurality of computer systems and like type general and/or specific purpose devices and systems. The one or more of the servers 110 may be coupled to a PSTN gateway 130, which in turn is coupled to the PSTN 106. The PSTN 106 provides conventional telephone service to a plurality of telephones 132.

Various customer premises equipment (CPE) 112 are coupled to the IP network 108 via links 128. Various communication devices 114 may be coupled to the CPE 112. The CPE 112 may include modems, terminal adapters, routers, and the like configured to provide an interface between the communication devices 114 and the IP network 108. The communication devices 114 may comprise telephones, video phones, computers, mobile devices, and the like. The CPE 112 and the communication devices 114 may be distributed among a plurality of subscribers to VOIP services provided by the VOIP network 104. The links 128 may include cable, digital subscriber line (DSL), or like type communication links known in the art.

In general operation, subscribers use the communication devices 114 and the CPE 112 to convert content (e.g., voice, video, data, some or all of which may be analog) and signaling into VOIP-based content and signaling (“a VOIP call”). VOIP calls may be transmitted to the IP network 108 via the CPE 112 over the links 128. Those skilled in the art will appreciate that the VOIP calls may pass through other IP networks before reaching the IP network 108 of the VOIP network 104. For example, the VOIP calls may pass through various IP networks of the Internet before being routed to the IP network 108 (e.g., internet service provider (ISP) networks, backbone networks, etc.). VOIP calls may be processed by the servers 110. VOIP calls may be directed to other subscribers of the VOIP network 104, to subscribers of other VOIP networks (not shown), or to subscribers of traditional telephone services (e.g., the PSTN 106).

Some aspects of the invention relate to providing an automated shopping service using an IP-based telecommunication system, such as the VoIP network 104. Generally, when a subscriber activates their service (i.e., a VoIP service), they have access to a number of features, such as but not limited to call features like call waiting, call forwarding, do not disturb, caller ID, and the like. Additionally, the subscriber may have access to other IP-based services, such as instant messaging, email, and the like. Tying services and features together adds to the flexibility and pervasiveness of the services in general so that their adoption becomes increasingly widespread. In some embodiments, the VoIP network 104 provides an automated shopping service so that a subscriber may receive information related to purchasing goods or services (generally referred to as “items”) desired by the subscribers. The automated shopping service may be facilitated by the shopping service server 102. For clarity, only a single server 102 is shown as facilitating an automated shopping service. Those skilled in the art will appreciate that the communication system 100 may include more than one server 102 to facilitate the automated shopping service as described herein.

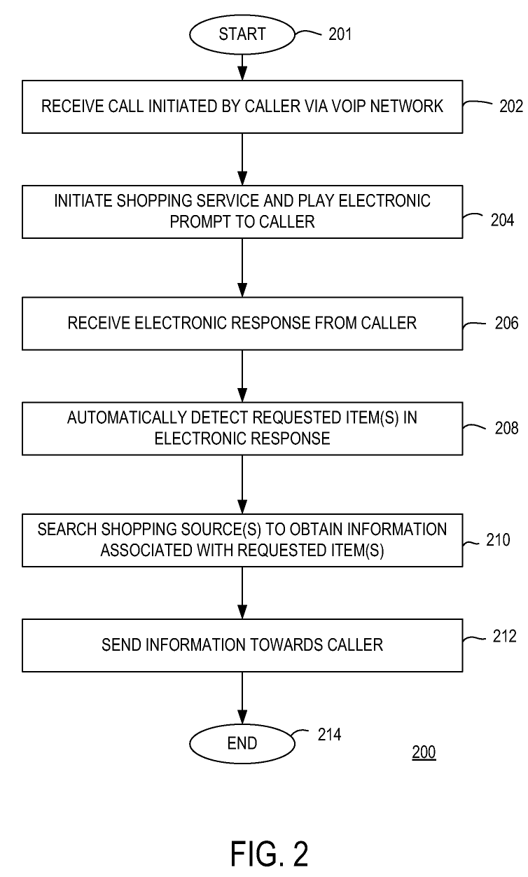

FIG. 2 is a flow diagram depicting an exemplary embodiment of a method 200 for providing an automated shopping service using a telecommunications system in accordance with one or more aspects of the invention. Aspects of the method 200 may be described with respect to the communication system 100 of FIG. 1. In particular, the method 200 may be performed by one or more servers, such as the server(s) 110 and/or the shopping service server 102. For purposes of clarity by example, the method 200 is described below with respect to being substantially performed by the shopping service server 102.

The method 200 begins at step 201 and proceeds to step 202, where a call initiated by a caller (e.g., a subscriber) is received via the VoIP network 104. The caller may initiate the call using a communication device 114 and CPE 112. For example, the caller may call a pre-defined telephone number, such as 700-CALL-SANTA, where the VOIP network 104 routes calls to that number to the shopping service server 102. In some embodiments, Session Initiation Protocol (SIP) is used to establish the call to the shopping service server 102. SIP was developed by the Internet Engineering Task Force (IETF) and published in 2002 as RFC 3261, which is herein incorporated by reference. Those skilled in the art will appreciate that other protocols may be used to establish calls in a VoIP network.

At step 204, the shopping service server 102 answers the call and initiates the shopping service by playing an electronic prompt to the caller. For example, the shopping service server 102 may play pre-recorded content to provide an introductory greeting to the caller that describes the service. The shopping service server 102 may play pre-recorded content providing descriptions of different shopping services that are available, different items available for purchase or being promoted, and the like. Notably, the VOIP network 104 may provide a plurality of different types of shopping services. In some embodiments, each type of shopping service may be associated with a different telephone number and with a different shopping service server. In some embodiments, a particular telephone number may be associated with a plurality of different types of shopping services and the shopping services server 102 allows the caller to select among the different services via the electronic prompt.

In some embodiments, the shopping service server 102 may employ an interactive voice response (IVR) or other type of menu system. The menu system may present the different types of shopping services available (if multiple types are handled by the electronic greeting server 102). The menu system may also present descriptions of the different shopping services available. In one embodiment, the shopping service may be based on a Christmas holiday, where a caller calls a theme based telephone number (e.g., 700-CALLSANTA) and Santa prompts the caller to describe the gifts they want to purchase. One skilled in the art can easily provide any number of alternate shopping services for the caller to select from, including but not limited to those based on traditional, observed holidays and themes such as Santa Claus/Christmas, Kwanza, General Seasons Greetings, Happy New Year (Western or Chinese observed), St. Patrick's Day, Easter, Mothers Day, Fathers Day, Grandparents Day, Memorial Day, July 4, Labor Day, Halloween, or Thanksgiving. Such shopping services may be selectable at the originally dialed number (accessing a first shopping service server) or by dialing alternate holiday-oriented telephone numbers (accessing a second or more shopping service servers or different menus/access points of the first shopping service server). Alternately, the shopping service may be of a more personal, non-holiday specific event including but not limited to engagements, weddings, anniversaries, birthdays, religious celebrations, and the like. Those skilled in the art will appreciate that a myriad of possible shopping services and associated themes may be provided.

As is known in the art, the caller may make selections on the menu system via voice response or by sending dual tone multi-frequency (DTMF) tones from their communication device. In some embodiments, the pre-recorded content may be audio content. The audio content may be played during calls to conventional telephones or other communication devices capable of displaying audio content to users. In other embodiments, the pre-recorded content may comprise video content. For example, the caller to the shopping service server 102 may have communication devices with video capabilities. In such cases, the shopping service may include one or more items of video content. In addition, in cases where the caller has a communication device with video capabilities, the menu systems employed may be implemented using graphical user interface (GUI).

At step 206, an electronic response is received from the caller in response to the electronic prompt. In some embodiments, the electronic response is a voice response specifying the item(s) desired. Other types of electronic responses may be received in addition to or as an alternative to voice response, such as DTMF tones, GUI interaction, and the like.

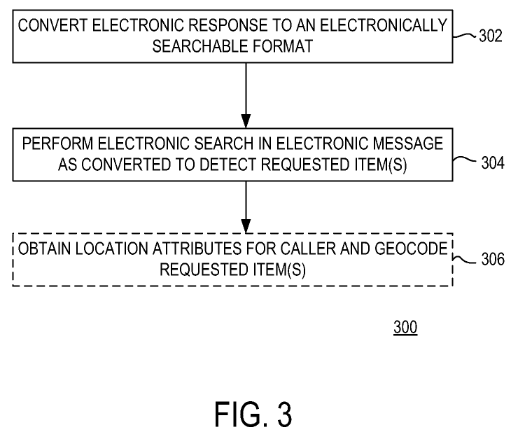

At step 208, at least one item requested by the caller is automatically detected in the electronic response. FIG. 3 is a flow diagram depicting an exemplary embodiment of a method 300 for automatically detecting items requested by the caller within an electronic response in accordance with one or more aspects of the invention. The method 300 begins at step 302, where the electronic response is converted to an electronically searchable format. For example, the electronically searchable format may be a digital audio format, such as a WAV file, MP3 file, or the like known in the art. At step 304, an electronic search is performed in the electronic response as converted to detect requested item(s). For example, the shopping service server 102 may perform a speech-to-text conversion of the electronic response to generate a text transcript thereof. The shopping service server 102 may then parse the transcript to detect the requested item(s). Such speech-to-text conversion and keyword parsing are well known in the art.

At optional step 306, location attributes associated with the caller are obtained and the requested item(s) detected in step 304 are geocoded based on the location attributes. The method 300 may employ various techniques to obtain location attributes for the caller, such as by analyzing an IP address of the caller's communication device or wireless access point depending on whether the communication device is a wired or wireless IP device, identifying cellular locations if using a dual mode type phone that has accessed a cellular network, identifying the caller and looking up subscriber information for the caller in a database (e.g., identifying the caller's home address), prompting/receiving the caller's location through the electronic prompt at step 204, or the like.

Returning to FIG. 2, at step 210, a search of at least one shopping source is performed to obtain information associated with the requested item(s) detected at step 208. Exemplary shopping sources include: Internet websites of manufacturers, distributors, retailers, etc; electronic catalogs (either over the Internet or locally maintained by the VoIP network 104) provided by manufacturers, distributors, retailers, etc.; Internet or other network portals provided by 3^{rd} parties that search for and compile lists of sources for items; and like type of electronically searchable sources of items for sale known in the art. Various types of information associated with the requested item(s) may be obtained, including a list of sources of the requested item(s) and associated attributes, such as sale price, whether item(s) are in stock, number of the item(s) in stock, shipping information, method of payment information, or any other of a myriad of attributes known in the art. As noted above, in some embodiments, the requested item(s) are geocoded based on location attributes of the caller. Accordingly, in some embodiments, the search performed at step 210 can be geo-filtered based on the location attributes. For example, the shopping service server 102 may select one or more shopping sources from a plurality of available shopping sources based on geographic identification data associated with the requested item(s) as geocoded. The geo-filtering may be performed in order to limit a search for the requested item(s) such that the search only identifies requested items located within a particular geographical area. For example, a geographical area of a certain size centered on the subscriber's home address can be used.

At step 212, the information associated with the requested item(s) is sent towards the caller. The information may be sent using at least one communication service. For example, the shopping service server 102 may obtain contact information associated with the caller. The contact information may be obtained from subscriber information maintained by the VoIP network 104 or directly from the caller during the electronic prompt at step 204. The contact information may indicate one or more mechanisms for contacting the caller, including electronic mail address, mobile telephone number, instant messaging (IM) address, or the like. The information can then be sent using various communication services, such as electronic mail, short message service (SMS), IM service, or the like. Accordingly, the VoIP network 104 may be coupled to various communication networks 150 that provide different communication services that can be used to send the information to the caller (e.g., mobile telephone network for SMS messaging). In addition, as noted above, the VoIP network 104 can be coupled to the Internet for accessing electronic mail, IM, and like type services. The method 200 then concludes at step 214.

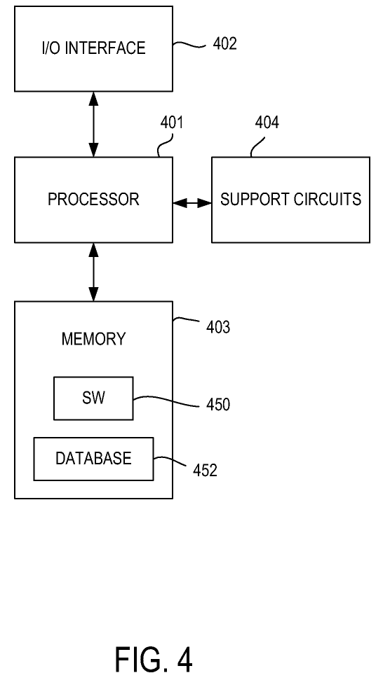

FIG. 4 is a block diagram depicting an exemplary embodiment of the shopping service server 102 in accordance with one or more aspects of the invention. The server 102 may be one of any form of a general purpose computer used in accessing and operating within an IP-based network. The shopping service server 102 may include a processor 401, a memory 403, various support circuits 404, and an I/O interface 402. The processor 401 may include one or more microprocessors or the like known in the art. The support circuits 404 include conventional cache, power supplies, clock circuits, data registers, and the like. The I/O interface 402 is configured for communication with the IP network 108. The memory 403, or computer readable medium, may include one or more of the following random access memory, read only memory, magneto-resistive read/write memory, optical read/write memory, cache memory, magnetic read/write memory, and the like. The I/O interface 402 may be coupled to other servers, databases, and the like. For example, the I/O interface 402 may be coupled to one or more of the servers 110 for obtaining subscriber information for a caller.

The memory 403 may store software 450 that is executed to perform methods of providing an automated shopping service, as described herein. The memory 403 may also store a database 452 of pre-recorded electronic content for use in the electronic prompt (e.g., step 204). The software 450, when executed by the processor 401, transforms the general purpose computer into a specific purpose computer that controls the automated shopping service process. Although embodiments of the process of the present invention are discussed as being implemented as a software routine, some of the method steps that are disclosed herein may be performed in hardware or a combination of hardware and software. As such, the invention may be implemented in software as executed upon a computer system, in hardware as an application specific integrated circuit or other type of hardware implementation, or a combination of software and hardware.

Additionally, the software 450 may be used to automatically manage one or more additional services that the telecommunications service provider offers, such as an instant messaging (IM) service, an email service, or a combination of these services or other services known to those skilled in the art of telecommunications. Further, the software 450 may act as a “stand alone” program or may be embedded with one or more other routines or programs that provide one or more additional telecommunication services. The software 450 of the present invention is capable of being executed on computer operating systems including but not limited to Microsoft Windows 98, Microsoft Windows XP, Apple OS X and Linux. Similarly, the software 450 of the present invention is capable of being performed using CPU architectures including but not limited to Apple Power PC, AMD/Intel x86, Sun SPARC, and Intel ARM.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method of providing an automated shopping service in a telecommunication system, comprising:
receiving a call via the telecommunication system initiated by a caller;
playing an electronic prompt to the caller;
receiving an electronic response from the caller to the electronic prompt;
automatically detecting at least one item requested by the caller in the electronic response;
performing a search of at least one shopping source to obtain information associated with the at least one item; and
sending the information towards the caller.

2. The method of claim 1, wherein the step of automatically detecting comprises:
converting the electronic response to an electronically searchable format; and
performing an electronic search in the electronic response as converted to detect the at least one item.

3. The method of claim 2, wherein the electronically searchable format comprises a digital audio format, and wherein the step of performing the electronic search comprises:
performing a speech-to-text conversion of the digital audio format to generate a transcript; and
parsing the transcript to detect the at least one item.

4. The method of claim 3, wherein the step of performing the electronic search further comprises:
obtaining location attributes associated with the caller; and
geocoding the at least one item based on the location attributes.

5. The method of claim 4, wherein the step of performing the search comprises:
selecting the at least one shopping source from a plurality of shopping sources based geographic identification data associated with the at least one item as geocoded.

6. The method of claim 1, wherein the step of sending comprises:
obtaining contact information associated with the caller; and
sending the information to the caller via at least one communication service.

7. The method of claim 6, wherein the at least one communication service comprises at least one of: electronic mail service, short message service (SMS), or instant messaging service.

8. The method of claim 1, wherein the telecommunication system includes an internet protocol (IP) communication network, and wherein the call is received using a voice-over-internet protocol (VOIP) service over the IP communication network.

9. An apparatus for providing an automated shopping service in a telecommunication system, comprising:
a database configured to store pre-recorded electronic content; and
at least one server configured to:
receive a call via the telecommunication system initiated by a caller;
play an electronic prompt to the caller selected from the pre-recorded content;
receive an electronic response from the caller to the electronic prompt;
automatically detect at least one item requested by the caller in the electronic response;
perform a search of at least one shopping source to obtain information associated with the at least one item; and
send the information towards the caller.

10. The apparatus of claim 9, wherein the at least one server is further configured to:
convert the electronic response to an electronically searchable format; and
perform an electronic search in the electronic response as converted to detect the at least one item.

11. The apparatus of claim 10, wherein the electronically searchable format comprises a digital audio format, and wherein the at least one server is further configured to:
perform a speech-to-text conversion of the digital audio format to generate a transcript; and
parse the transcript to detect the at least one item.

12. The apparatus of claim 11, wherein the at least one server is further configured to:
obtain location attributes associated with the caller;
geocode the at least one item based on the location attributes.

13. The apparatus of claim 12, wherein the at least one server is further configured to:
select the at least one shopping source from a plurality of shopping sources based geographic identification data associated with the at least one item as geocoded.

14. The apparatus of claim 9, wherein the at least one server is further configured to:
obtain contact information associated with the caller; and
send the information to an address of the caller via at least one communication service.

15. The apparatus of claim 14, wherein the at least one communication service comprises at least one of: electronic mail service, short message service (SMS), or instant messaging service.

16. The apparatus of claim 9, wherein the telecommunication system includes an internet protocol (IP) communication network, and wherein the call is received using a voice-over-internet protocol (VOIP) service over the IP communication network.

17. A computer readable medium having stored thereon instructions that when executed by a processor cause the processor to perform a method of providing an automated shopping service in a telecommunication system, comprising:
receiving a call via the telecommunication system initiated by a caller;
playing an electronic prompt to the caller;
receiving an electronic response from the caller to the electronic prompt;
automatically detecting at least one item requested by the caller in the electronic response;
performing a search of at least one shopping source to obtain information associated with the at least one item; and
sending the information towards the caller.

18. The computer readable medium of claim 17, wherein the step of automatically detecting comprises:
converting the electronic response to an electronically searchable format; and
performing an electronic search in the electronic response as converted to detect the at least one item.

19. The computer readable medium of claim 18, wherein the electronically searchable format comprises a digital audio format, and wherein the step of performing the electronic search comprises:
performing a speech-to-text conversion of the digital audio format to generate a transcript; and
parsing the transcript to detect the at least one item.

20. The computer readable medium of claim 19, wherein the step of performing the electronic search further comprises:
obtaining location attributes associated with the caller;
geocoding the at least one item based on the location attributes; and
wherein the step of performing the search comprises:
selecting the at least one shopping source from a plurality of shopping sources based geographic identification data associated with the at least one item as geocoded.
